(19) United States
(12) Patent Application Publication
(10) Pub. No.: US 2026/0004120 A1
(43) Pub. Date: Jan. 1, 2026

(54) OPTIMIZING SEQUENCES OF FEW-SHOT EXAMPLES FOR LARGE LANGUAGE MODELS

(71) Applicant: INTUIT INC., Mountain View, CA (US)

(72) Inventors: Xiang GAO, Clyde Hill, WA (US); Kamalika DAS, Saratoga, CA (US)

(21) Appl. No.: 18/757,673

(22) Filed: Jun. 28, 2024

(51) Int. Cl. G06N 3/08

(52) U.S. Cl. CPC G06N 3/08

(57) ABSTRACT

Aspects of the present disclosure relate to automated determination of an optimized sequence of examples for few-shot learning. Embodiments include generating, via a text encoder of an embedding model, embedding representations of training examples and a query. Embodiments further include generating, via a sequence encoder of the embedding model, embedding representations of two or more sequences of the training examples based on the training example embeddings. Embodiments further include determining, based on comparing the embedding representations of the sequences to the embedding representation of the query, probabilities that each sequence of the two or more sequences is a most optimized sequence for the query. Embodiments further include modifying parameters of the embedding model through a supervised contrastive learning process that involves evaluating the determined probabilities based on a label that indicates the most optimized sequence of the two or more sequences for the query.

### INTRODUCTION

Aspects of the present disclosure relate to techniques for optimizing the sequence of few-shot examples for use in few-shot learning techniques for language processing machine learning models. In particular, techniques described herein involve training and/or fine-tuning embedding models to generate embeddings for sequences and queries. The trained and/or fine-tuned embedding models may then be used to compare the sequences to the queries, and an optimized sequence may be selected based on the comparing.

### BACKGROUND

A growing number of people, businesses, and organizations around the world utilize language models to assist with a wide variety of tasks. For example, a user may request that a language model generate a certain type of content, and the language model may generate the content based on the request.

To perform tasks, language models must first be trained on a set of data. Language models may also be provided with context that is applicable to a particular task through a process known as few-shot learning. Few-shot learning involves providing the language model with a sequence of examples related to a task. In few-shot learning, the language model may learn from these examples and thus perform the task. Few-shot learning allows for quick and efficient “training” of a language model, since a relatively small number of examples may be needed (as opposed to other forms of training, which may involve much larger datasets). However, deficiencies in the few-shot datasets used to provide inputs to models may lead to ineffective and/or erroneous responses. Existing techniques for removing these deficiencies may involve manually determining an optimal combination of few-shot examples through brute force testing; one combination of examples may result in a response that is better than other responses, and this response may be chosen as the response for the query. However, such brute force testing defeats the purpose of few-shot learning, which is to efficiently provide a model with information that is useful for responding to a query. Automated techniques for determining a combination of few-shot examples exist, but these techniques often fail to determine an optimal combination of few-shot examples.

Thus, there is a need in the art for improved techniques of determining an optimal combination of few-shot examples for few-shot learning processes.

### BRIEF SUMMARY

Certain embodiments provide an automated method of training a model to determine an optimal combination of few-shot examples for few-shot learning processes. The method generally includes: generating, via a text encoder of an embedding model, embedding representations of training examples; generating, via the text encoder of the embedding model, an embedding representation of a query; generating, via a sequence encoder of the embedding model, embedding representations of two or more sequences of the training examples based on the embedding representations of the training examples; determining, based on comparing the embedding representations of the sequences to the embedding representation of the query, probabilities that each sequence of the two or more sequences is a most optimized sequence of the two or more sequences for the query; and modifying parameters of the embedding model through a supervised contrastive learning process that involves evaluating the determined probabilities based on a label that indicates the optimized sequence of the two or more sequences for the query.

Other embodiments provide an automated method of determining an optimal combination of few-shot examples for few-shot learning processes. The method generally includes: generating, via a text encoder of an embedding model, embedding representations of few-shot examples; generating, via a sequence encoder of the embedding model, embedding representations of two or more sequences of the few-shot examples based on the embedding representations of the few-shot examples; generating, via the text encoder of the embedding model, an embedding representation of a query; selecting, based on comparing the embedding representations of the two or more sequences to the embedding representation of the query, a most optimized sequence of the two or more sequences for the query; and generating a response to the query using a language processing machine learning model, wherein the language processing machine learning model is provided with the selected most optimized sequence as few-shot learning examples in association with the query.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated determination of an optimal combination of few-shot examples for few-shot learning processes.

FIG. 2 depicts an additional example of computing components related to automated determination of an optimal combination of few-shot examples for few-shot learning processes.

FIG. 3 depicts an additional example of computing components related to automated determination of an optimal combination of few-shot examples for few-shot learning processes.

FIG. 4A depicts experimental results achieved using various sequence optimization techniques.

FIG. 4B depicts additional experimental results achieved using various sequence optimization techniques.

FIG. 5 depicts experimental results achieved using various embodiments.

FIG. 6 depicts example operations related to automated determination of an optimal combination of few-shot examples for few-shot learning processes.

FIG. 7 depicts additional example operations related to automated determination of an optimal combination of few-shot examples for few-shot learning processes.

FIG. 8 depicts an example of a processing system for automated determination of an optimal combination of few-shot examples for few-shot learning processes.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically determining of an optimal combination of few-shot examples for few-shot learning processes.

According to certain embodiments, a sequence optimization model may be trained through a contrastive learning process to determine an optimal combination of few-shot examples for providing to a language processing machine learning model (such as a large language model, or LLM) in connection with prompting the model to respond to a query. The optimal combination of examples may be determined based on finding an optimal sequence for a given set of few-shot examples. For example, according to embodiments of the present disclosure, sequences that are more semantically similar to a given query than other sequences may lead to more effective few-shot training of a language processing machine learning model (i.e., a language processing machine learning model trained through few-shot learning using a sequence that is more semantically similar to the query may generate a better response to the query). Thus, through the use of a sequence optimization model that is trained to consider the semantic similarity between few-shot examples and a given query and also consider the sequential ordering of few-shot examples for use in few-shot learning for the given query, techniques described herein overcome the technical challenge of identifying an optimal sequence of few-shot learning examples to use for a particular query, and avoid the selection of suboptimal few-shot examples and/or sequences of such examples (e.g., that could otherwise be selected due to deficiencies in databases from which few-shot examples are selected and/or deficiencies in prior art few-shot example selection techniques such as random selection and/or ordering).

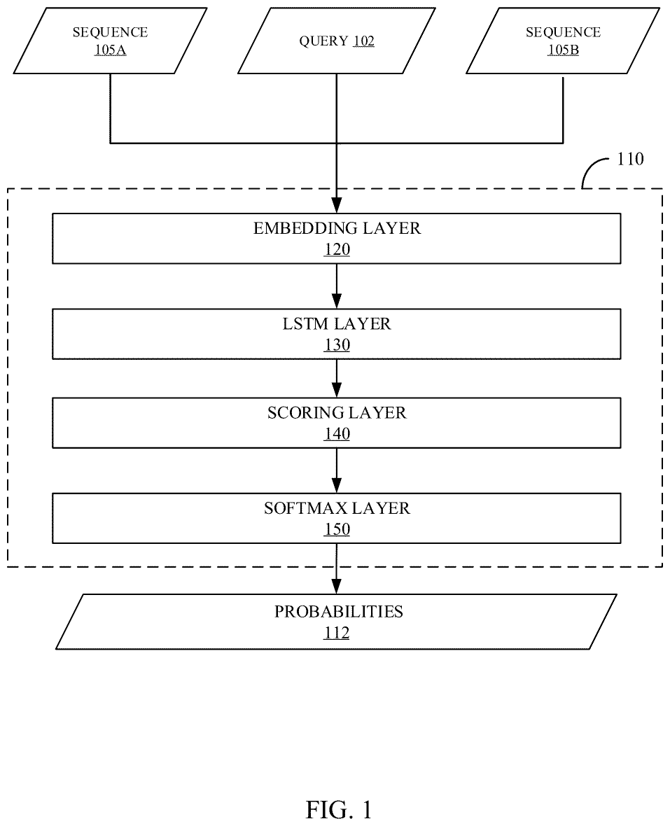

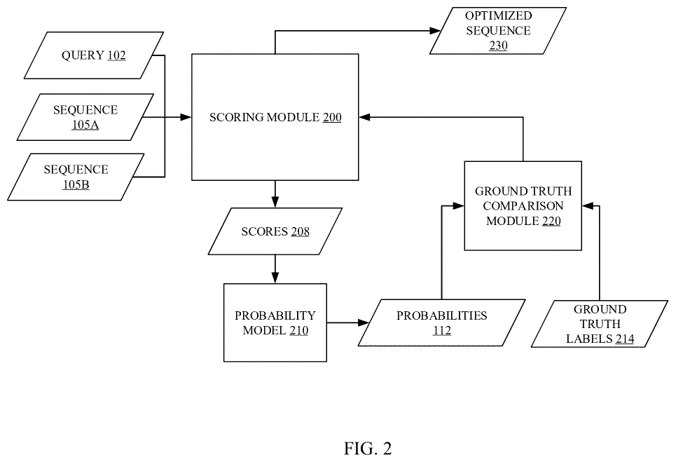

As described in more detail below with respect to FIG. 2, training a sequence optimization model to determine an optimal sequence of examples for a query may comprise generating embedding representations of a training query and sequences of training examples. The training sequence embeddings (e.g., embeddings of sequences of training examples, such as produced by a sequential analysis model such as a long short-term memory (LSTM) model) may be compared to the training query embedding to generate a probability that each training sequence is an optimal sequence for the training query (e.g., that that sequence performs better than the other sequences). The probabilities may be compared to ground-truth labels that indicate which sequence is the optimal sequence, and the embedding model may be trained based on the comparison through a contrastive learning process (e.g., that is contrastive in the sense that it contrasts multiple sequences with one another and is based on ground truth labels indicating which of the multiple sequences is the most optimal). In certain embodiments, the embedding model is fine-tuned such as by using training data associated with a given query in order to generate a response to the given query. The trained and/or fine-tuned embedding model may be part of a sequence optimization model that is used to determine an optimal sequence of few-shot examples for a particular query. Example implementations and use of such a sequence optimization model are described in more detail below with respect to FIGS. 1-3.

Embodiments of the present disclosure provide numerous technical and practical effects and benefits. Testing has shown that the few-shot example determination techniques disclosed herein outperform other techniques known in the prior art for automatically determining few-shot examples. For instance, prior art solutions fail to consider the sequence of few-shot examples in determining which examples to use. In many cases, a correlation exists between the similarity of few-shot examples to a query and the effectiveness of the few-shot examples for generating a response to the query. Thus, a sequence of examples that is most similar to the query may be a sequence that is most effective in generating a response to the query. Accordingly, by providing a system for automatically determining a few-shot example sequence based on similarity to a given query, embodiments of the present disclosure lead to improvements in few-shot response generation for language processing machine learning models.

Furthermore, teachings disclosed herein approach the effectiveness of brute force testing and labeling for every sequence while using a fraction of the computing resources required by such brute force testing. For instance, while brute force testing may require comparing language model outputs for every possible sequence (or a large proportion of the possible sequences) in order to determine a sequence that generates the best output, teachings disclosed herein allow for reliably determining an optimal sequence of few-shot examples for a query without brute force testing involving the query (or, when fine-tuning is used, performing brute force testing with only a relatively small portion of possible sequences).

### Example of Computing Components Related to Automated Determination of an Optimal Combination of Few-Shot Examples for Few-Shot Learning Processes

In few shot learning, a pre-trained machine learning model that has not necessarily been trained for a specific domain or purpose is provided with a relatively small number (e.g., relative to the amount of training data that is used to train the model overall) of examples, which may be labeled training data instances, for that specific domain or purpose in order to prime the pre-trained machine learning model to make a prediction for a given set of input features relating to that specific domain or purpose. For example, the relatively small number of examples may be provided as part of a prompt to the pre-trained machine learning model along with the input features for which a prediction or inference is being requested (e.g., a query), and the pre-trained machine learning model uses the relatively small number of examples as in-context reference points that assist in making a prediction based on the input features.

A sequence optimization model 110 may be used for determining an optimal sequence of examples for few-shot learning. FIG. 1 describes an example implementation of such a sequence optimization model 110 as a single machine learning model (e.g., a neural network). Although the components in FIG. 1 are described as part of a single neural network, other implementations are possible. For example, the components depicted in FIG. 1 may each be separate computing components or part of separate machine learning models.

In some embodiments, training data for a sequence optimization model 110 comprises training examples. A sequence 105 for the training examples may comprise a combination of the examples in a particular order. The training data may include a subset of the set of all possible sequences for the training examples. In certain embodiments, the subset may be selected randomly. The training data may also comprise a training query 102. An optimal sequence for the training examples (i.e., a sequence of the sequences that results in the most successful few-shot learning compared to other sequences for the training examples) may be known (e.g., in the form of a ground truth label). For example, the optimal sequence may be determined by manual and/or automated testing, such as by providing a language processing machine learning model with each sequence as few-shot learning examples in connection with a task and then assessing the performance of the language processing machine learning model for the task when provided with the different sequences of few-shot learning examples. The sequence that causes the language processing machine learning model to generate the best response to the query (e.g., a generated response that is closest to a response that has been confirmed to be correct, a generated response that has itself been manually confirmed to be better than other generated responses, and/or the like) may be labeled as the optimal sequence for the query, and such a label may be included in ground truth labels.

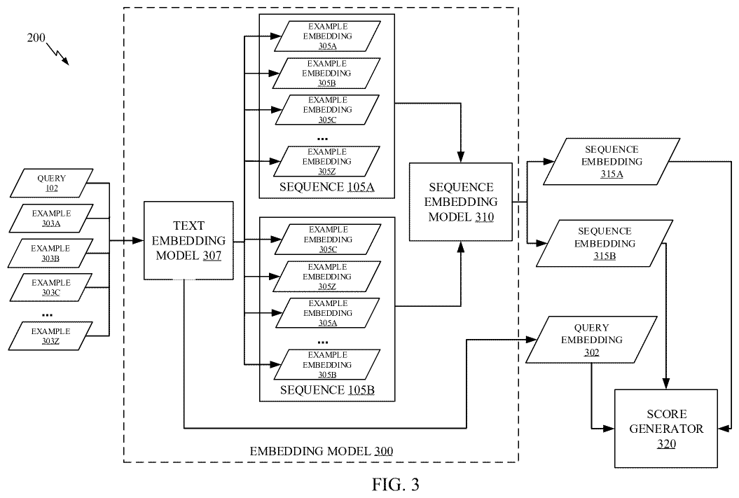

Sequence optimization model 110 may comprise an embedding layer 120 which may create embedding representations of few-shot examples (e.g., which are included in sequences 105) and queries 102. Embedding layer 120 may correspond to text embedding model 207 of FIG. 3, discussed below. An embedding generally refers to a vector representation of an entity that represents the entity as a vector in n-dimensional space such that similar entities are represented by vectors that are close to one another in the n-dimensional space. Embeddings may be generated through the use of an embedding model, such as embedding layer 120 or another type of machine learning model that learns a representation (embedding) for an entity through a training process that trains the neural network based on a data set, such as a plurality of features of a plurality of entities. The query 102 and each example 105 may be represented by a corresponding embedding vector.

Sequence optimization model 110 may further comprise an LSTM layer 130. LSTM layer 130 may be used to generate embeddings of sequences 105 based on the example embeddings 305 of FIG. 3 (such as by aggregating the example embeddings 305 into a single embedding that represents a sequence 105). LSTM layer 130 may correspond to sequence embedding model 310 of FIG. 3, discussed below. In some embodiments, generating a query embedding may further comprise using a multi-layer perceptron (MLP) to map the encoded query text into the latent space occupied by the sequence embedding.

Sequence optimization model 110 may further comprise a scoring layer 140, which is configured to generate scores for each sequence 105 based on the level of similarity between an embedding of a sequence and an embedding of a query. Scoring layer 140 may correspond to score generator 320 of FIG. 3, discussed below. The score for a sequence 105 may be generated by determining the dot product between the an embedding of a sequence 105 and an embedding of a query 102, determining the cosine similarity between the sequence embedding and the query embedding, or similar methods of determining similarity between two embeddings. Some embodiments provide that the query embedding and the sequence embedding may be concatenated and compared using an MLP to determine the similarity. The determined level of similarity may be used as a score (and/or used to determine a score) for the sequence 105 (e.g., such that a higher level of similarity leads to a higher score).

Sequence optimization model 110 may further comprise a softmax layer 150, which is configured to generate probabilities 112 based on the scores. The probabilities 112 may be interpreted as a likelihood that each sequence 105 will be effective for generating a response to a query 102 because of the correlation between the similarity of a sequence 105 to a query 102 and the effectiveness of a sequence 105 of few-shot examples. For example, the softmax layer 150 may receive the scores for various sequences 105 as input and output a probability distribution based on the scores. A softmax function is a type of squashing function with an output limited to the range of 0 to 1, thereby allowing the output to be interpreted directly as a probability. Softmax functions are multi-class sigmoids, and they may be used in determining probabilities of multiple classes at once. The outputs of the softmax function may be interpreted as a probability of effectiveness for a sequence 105 because the effectiveness of a sequence 105 of examples may be closely correlated to the similarity between the sequence 105 and the query 102, as discussed in further detail below. In some embodiments, the softmax layer receives scores for a set of sequences 105 and generates probabilities that a respective sequence 105 of each set produces a better result than the other sequences 105 of the set.

According to some embodiments, the probabilities 112 may be compared to ground truth labels that indicate that a sequence of a set of training sequences is the most optimized sequence of the set of training sequences for a training query. For example, cross-entropy loss for the probabilities 112 may be determined based on the label. Cross-entropy generally measures the performance of a model whose output is a probability value between 0 and 1. Cross-entropy loss increases as the output probability diverges from the training labels. For example, predicting a probability of 0.014 when the label is 1 (e.g., when the label indicates that the sequence is the optimal sequence for the query) would result in a higher loss value than predicting a probability of 0.9 when the label is 1. An ideal set of predictions would have a cross-entropy loss value of 0.

Some embodiments provide that, based on the comparison of the probabilities 112 to the training labels (or based on otherwise comparing a selected sequence of examples to a sequence indicated by the training labels), a component used to generate embeddings (such as the embedding layer 120 and/or LSTM layer 130) may be retrained. Retraining an embedding model may comprise adjusting parameters of the embedding model or otherwise reconfiguring the embedding model to generate embeddings of queries 102 and examples 105 that are optimized for comparing the queries 102 and examples 105. For example, an embedding model that is retrained based on comparing the generated probabilities 112 to the training labels may generate embeddings that result in less variance between the probabilities 112 and the labels. Retraining an embedding model such as embedding layer 120 and/or LSTM layer 130 may comprise adjusting the granularity at which the model creates embeddings (e.g., adjusting the number of words/characters covered by each embedding).

According to certain embodiments, the embedding model may be fine-tuned for a particular type of query provided by a user. The fine-tuning may comprise training a language processing machine learning model using a subset of possible sequences of examples and generating a response to the query based on each sequence of the subset. The subset may comprise randomly selected sequences, and the subset may be a small percentage of the total possible sequences. The responses may be evaluated such as through a manual and/or automated response evaluation test, and the sequence of examples that resulted in the best response (e.g., the response that is closest to a model response) may be labeled as the optimal sequence for the query. The particular query may be provided to the sequence optimization model 110, where an embedding representation of the query may be generated and compared to embedding representations of the sequences to determine probabilities that each sequence is the most optimized sequence for the query. The probabilities may be compared to ground-truth labels indicating which sequence is the most optimized sequence, and the embedding components of sequence optimization model 110 (such as embedding layer 120 and/or LSTM layer 130) may be fine-tuned based on the comparison (e.g., this training process may be referred to as a contrastive learning process). By fine-tuning a sequence optimization model 110 based on labeling a relatively small subset of example sequences, teachings of the present disclosure allow for greater efficiency in determining an optimized sequence of examples compared to brute force labeling the entire set of sequences.

In some embodiments, fine-tuning the sequence optimization model 110 may comprise fine-tuning for a particular language processing machine learning model. For example, one or more components of sequence optimization model 110 (such as embedding layer 120 and/or LSTM layer 130) may be trained, as described above, using training data associated with a first language processing machine learning model and/or otherwise that is not associated with a second language processing machine learning model and/or a particular type of query. A user may wish to determine an optimal sequence of few-shot examples for the second language processing machine learning model and a given query. A subset of the total possible sequences may be used to generate training data associated with the given query. This training data may be created based on evaluating outputs of the second language processing machine learning model in response to the sequences and the given query. The embedding components of sequence optimization model 110 may be fine-tuned based on the training data, resulting in a sequence optimization model that is fine-tuned for determining optimal sequences of few-shot training examples for the second language processing machine learning model.

Some embodiments provide that the retrained and/or fine-tuned sequence optimization model 110 may be used to determine the most optimized sequence for a particular query (such as a query for which the model was fine-tuned or corresponding to a type of query for which the model was fine-tuned). The optimized sequence for the particular query may be determined by creating an embedding representation of the particular query. Embedding representations of the examples and sequences may be stored in a vector store. In an example, a vector store is built for fast retrieval using, e.g., approximate nearest neighbor algorithms. The embedding representation of the particular query may be compared to the embedding representations of the sequences (such as by determining the dot product between the query embedding and sequence embeddings or using a nearest neighbor algorithm to search the vector store based on the query). The sequence that is most similar to the query may be selected as the few-shot sequence for training a language processing machine learning model to respond to the query.

FIG. 2 depicts an additional example of computing components related to automated determination of an optimal combination of few-shot examples for few-shot learning processes.

A query 102 and sequences 105A, 105B may be provided to a scoring module 200 that is configured to generate scores 208 for sequences 105. The query 102 may comprise a natural language prompt that indicates a task for a language processing machine learning model to perform. For example, the query 102 may comprise a question, and the task may be answering the question. Each sequence 105 may comprise a series of few-shot examples arranged in different orders. For example, sequence 105A may contain the same examples as sequence 105B arranged in a different order. The sequences 105 may be randomly selected from a set of possible sequences of examples. In some embodiments, each sequence 105 may contain examples not found in the other sequence 105. The examples may comprise hypothetical inputs such as prompts with labels indicating an appropriate and/or correct response to the input. Providing a language processing machine learning model with a sequence of few-shot examples may allow for training the model based on the examples via few-shot learning techniques. As discussed in further detail below, the query 102 and sequences 105A, 105B may be used (e.g., in conjunction with ground truth labels 214) as training data to train scoring module 200 to generate scores 208 for sequences 105 and/or select one or more sequences 105 for use in few-shot learning.

Scoring module 200, discussed in further detail below with respect to FIG. 3, may comprise a software component (e.g., running on one or more processors) configured to generate a score 108 for each sequence 105 and/or select sequences 105 for use in few-shot learning. Scoring module 200 may comprise an embedding model 300 (described below with respect to FIG. 3), which may comprise a text embedding model 307 of FIG. 3, a sequence embedding model 310 of FIG. 3, and a score generator 320 of FIG. 3. Scoring module 200 may generate a score 208 for a sequence 105 based on the similarity between query 102 and the sequence 105. For example, if query 102 and sequence 105A are highly similar, sequence 105A may be given a high score 208; if query 102 and sequence 105B have a low level of similarity, sequence 105B may be given a low score 208 (e.g., lower than the score that would be generated if query 102 and sequence 105A are highly similar). A sequence 105 with a higher score 208 may be selected for few-shot learning over a sequence 105 with a lower score 208.

For training the scoring module 200, the scores 208 may be provided to a probability model 210. The probability model 210 may comprise a softmax layer of a neural network that is configured to generate probabilities 112 based on scores 208. In one example, scoring module 200 and probability model 210 are part of a single neural network. The probability 112 may indicate the likelihood that, for a given query 102, one sequence 105 will result in more effective response generation than the other sequence 105. For example, for a given query X and two sequences of examples E₁ and E₂, the score generator 320 may output corresponding scores S₁=f(X, E₁) and S₂=f(X, E₂). These scores may be provided as input to a softmax function to obtain the predicted probability softmax ([S₁, S₂]). Such a probability 112 may be interpreted as a probability of success for a sequence 105 because of the correlation between the similarity of few-shot example sequences to a query 102 and the effectiveness of the few-shot example sequences for generating a response to the query 102.

Ground truth comparison module 220 may comprise one or more processors that are configured to compare the probabilities 112 to ground truth labels 214 associated with sequences 105. For example, the probabilities 112 may comprise a likelihood value between 0 and 1 that a sequence 105 of a set of sequences, if used as an ordered sequence of few-shot learning examples to train the scoring module 200, will result in a better response to a training query 102 than the other sequences 105. The ground truth comparison module 220 may be configured to determine the cross-entropy loss for the probabilities based on the label 214, or otherwise determine the level of variance between the predictions 112 and the labels 214, and parameters of scoring module 200 and/or probability model 210 may be updated based on the determined cross-entropy loss and/or level of variance (e.g., through an iterative supervised learning process). Operations of ground truth comparison module 120 may be referred to as contrastive learning operations.

The ground truth labels 214 may be determined by manual and/or automated testing, such as by training a language processing machine learning model using training sequences 105 and then assessing the performance of the language processing machine learning model in answering training queries 102 associated with the training sequences 105. The training sequence 105 that causes the language processing machine learning model to generate the best response to the associated training query 102 (e.g., a response that is closest to a sample/model response) may be labeled as a sequence 105 that performs better than other sequences 105 of a set of sequences. For example, the better-performing sequence 105 may receive a label of “1,” while the other sequence(s) 105 may receive a label of “0.”

Based on comparing the probabilities 112 to the ground truth labels 214, ground truth comparison module 220 may train the scoring module 200 and/or probability model 210. For instance, the embedding model 300 (e.g., the text embedding model 307 and/or the sequence embedding model 310) of scoring module 200 may be trained based on the level of variance between the probabilities 112 and the ground truth labels 214. Training the scoring module 200 may comprise adjusting parameters, hyperparameters, values related to granularity of embeddings (e.g., how many words/characters are covered by each embedding), weights, functions used by nodes, and/or the like. Such adjustments may be made in response to the variance between the probabilities 112 and the ground truth labels 214 exceeding a threshold. For example, such adjustments may be made until a sequence selected as the optimal sequence matches a sequence indicated by the ground truth labels 214.

In certain embodiments, scoring module 200 may be fine-tuned to a particular query, type of query, and/or a particular language processing machine learning model. For example, after the scoring module 200 has been retrained based on a given query and set of sequences, the scoring module 200 may be provided with a target query. Probabilities may be generated for the sequences relative to the target query, and the scoring module 200 may be fine-tuned based on the variance between these probabilities and training labels created for the sequences relative to the target query. The set of sequences used for fine-tuning the scoring module 200 may be a relatively small subset of the set of sequences used to retrain the scoring module 200.

Fine-tuning scoring module 200 to a particular language processing machine learning model may comprise providing the particular language processing machine learning model with a set of sequences (such as a small subset of the sequences 105 used to train the scoring module 200), evaluating the outputs of the particular model based on the sequences (such as through a manual and/or automatic benchmarking process), and then labeling a sequence that resulted in the best response to a query as an optimized sequence for the query and the particular model. The scoring module 200 may be fine-tuned based on the variance between the labels and the probabilities generated for the sequences.

Once scoring module 200 has been trained and/or fine-tuned, scoring module 100 may be used to determine an optimized sequence 230 to use for a query provided by a user (such as a query used for the fine-tuning, or a different query, such as of the same type as the query used for the fine tuning or a different type). The optimized sequence 230 for the user query may be determined by creating an embedding representation of the user query. The embedding representation of the user query may be compared to the sequence embeddings 315 (described below with respect to FIG. 3), such as by determining the dot product between the user query embedding and sequence embeddings 315 or using a nearest neighbor algorithm to search a vector store used to hold the sequence embeddings 315 based on the user query embedding. The sequence 105 that is most similar to the user query (e.g., based on the comparison of embeddings) may be selected as the optimized sequence 230 for the user query and used as a few-shot sequence for training a language processing machine learning model to respond to the user query.

FIG. 3 depicts an additional example of computing components related to automated determination of an optimal combination of few-shot examples for few-shot learning processes. Specifically, FIG. 3 depicts scoring module 200 of FIG. 2 in greater detail.

A query 102 and a series of few-shot examples 303A-Z may be provided to an embedding model 300. In one example, the embedding model 300 comprises text embedding model 307 which may be a text encoder such as a Bidirectional Encoder Representations from Transformer (BERT) model configured to generate embeddings of queries 102 and examples 303. BERT models may involve the use of masked language modeling to determine embeddings. In a particular example, the text embedding model 307 comprises a Sentence-BERT model. In other embodiments, the text embedding model 307 may involve embedding techniques such as Word2Vec and GloVe embeddings. These are included as examples, and other techniques for generating embeddings are possible. The text embedding model 307 may generate embeddings of the query 102 and each example 303. The example embeddings 203A-Z may be stored, such as in a vector store, and retrieved in order to generate sequence embeddings 315A, 315B.

Embedding model 300 may generate sequence embeddings 315 by aggregating each of the example embeddings 305 into a single embedding that represents a sequence 105. Such aggregation may be achieved using a sequence embedding model 310, which may be a sequence encoder such as a long short-term memory (LSTM) layer of a neural network, which may follow a text encoder layer of embedding model 300 (e.g., text embedding model 307). In some embodiments, sequence embedding model 310 retrieves example embeddings 305 from a vector store that links each example 303 to the corresponding example embedding 305 and uses the example embeddings 305 to create the sequence embeddings 315 based on the order of examples 303 in a sequence 105. Thus, the sequence embeddings 315 may be created for each sequence 105 without creating duplicate embeddings for the individual examples 303.

A query embedding 302 may be provided to a score generator 320 along with the sequence embeddings 315. The score generator 320 may comprise one or more processors configured to generate a score 208 for each sequence 105, such as by determining the dot product between the sequence embedding 315 corresponding to a sequence 105 and the query embedding 302, determining the cosine similarity between the sequence embedding 315 and the query embedding 302, or similar methods of determining similarity between two embeddings. Some embodiments provide that the query embedding 302 and the sequence embedding 315 may be concatenated and compared using a multi-layer perceptron (MLP) to determine the similarity. The determined level of similarity may be used as a score 208 (and/or used to determine a score 208) for the sequence such that a higher level of similarity leads to a higher score 208. As discussed above with respect to FIG. 1 and FIG. 2, the score 208 may be used to determine probabilities 112 that each sequence 105 is an optimized sequence for a query 102 and/or to select a sequence 105 for use with a query 102.

### Example Experimental Results Achieved Using Various Sequence Optimization Techniques

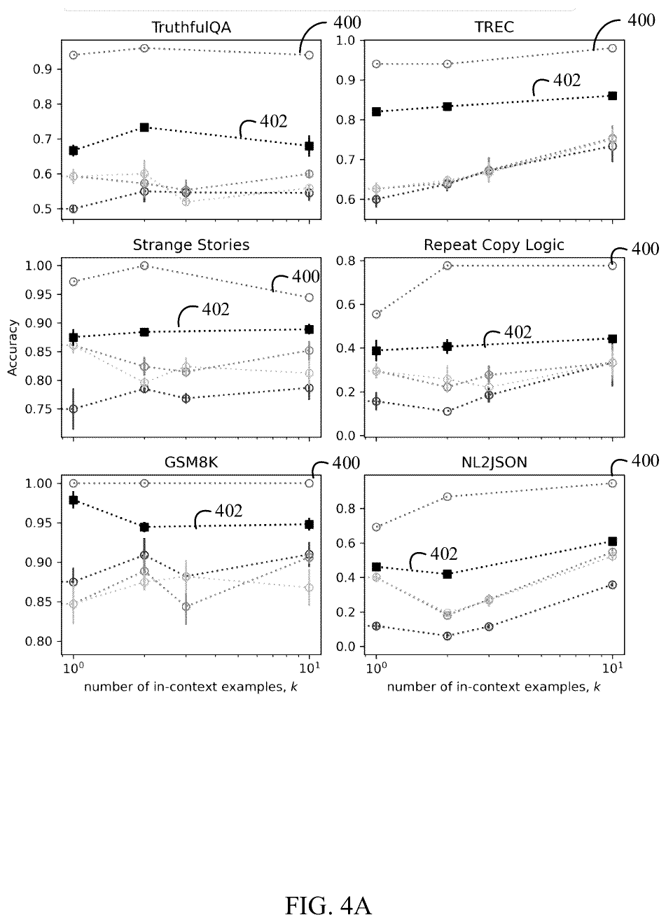

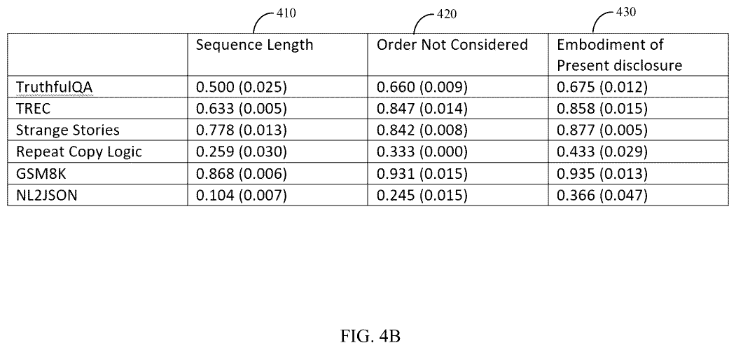

FIG. 4A depicts experimental results involving teachings disclosed herein compared to other techniques for determining an optimal sequence of few-shot examples.

The results depicted in FIG. 4A represent the accuracy of various sequence optimization techniques in choosing a sequence of few-shot examples as a function of the number k of examples used. The sequence optimization techniques were used to determine an optimal sequence of examples for six standardized few-shot learning benchmark datasets: TruthfulQA, GSM8K, Strange Stories, TREC, Repeat Copy Logic, and NL2JSON.

400 represents the theoretical upper bound of performance for the few-shot learning task. This upper bound is generally achievable only through brute force testing to determine an optimal sequence for a given query (as explained above, such brute force testing may defeat the purpose of few-shot learning, which is to efficiently and quickly optimize a machine learning model for a given task). As shown in this example, the upper bound was estimated by using a large number of example sequences in a few-shot learning process and finding the optimal sequence of the sequences used based on the outputs. For a k-shot task with N training examples e, there are (ₖ^{N}) possible combinations of examples to form an example sequence E={eᵢ}. M example sequences were used, where M=100 for k=1 and M=900 for larger k.

402 represents the performance of an embodiment of the present disclosure that has been fine-tuned for the particular dataset. As shown, the performance of the fine-tuned embodiment 402 exceeds the performance of other techniques, which include randomly selecting sequences of examples, using a k nearest neighbor algorithm to select individual examples that are similar to a query without considering sequence, and using Maximum Marginal Relevance to determine a sequence of examples. Also, the performance of the fine-tuned embodiment 402 approaches the performance of the upper bound 400.

FIG. 4B depicts additional experimental results involving teachings disclosed herein compared to other techniques for determining an optimal sequence of few-shot examples.

The results depicted in FIG. 4B represent the accuracy of various sequence optimization techniques in choosing a sequence of few-shot examples for the six standardized few-shot learning benchmark datasets described above with respect to FIG. 4A, with standard deviation shown in parentheses. Column 410 shows the accuracy of a technique that involves selecting few-shot examples based on sequence length. Column 420 shows the accuracy of a technique that involves selecting individual examples that are similar to a query without considering sequence. Column 430 shows the accuracy of an embodiment of the present disclosure. As shown, the embodiment of the present disclosure out-performs the other techniques across the various benchmark datasets.

### Example Experimental Results Achieved Using Various Embodiments

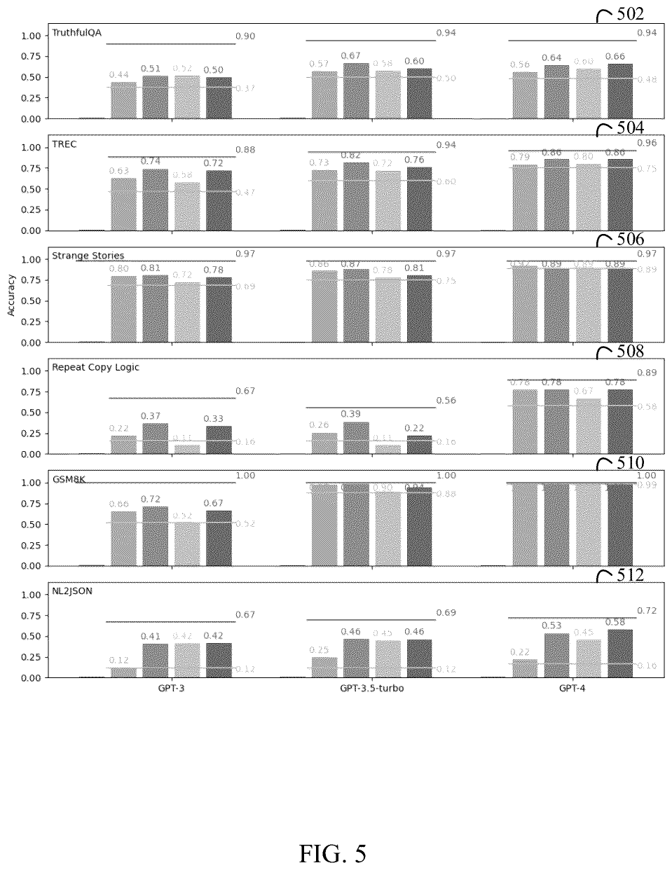

FIG. 5 depicts experimental results involving various embodiments of the present disclosure. Each bar graph within graphs 502, 504, 506, 508, 510, and 512, respectively, represents the performance of four embodiments on a particular respective benchmark dataset (TruthfulQA, TREC, Strange Stories, Repeat Copy Logic, GSM8K, or NL2JSON) using a particular machine learning model (GPT-3, GPT-3.5 Turbo, or GPT-4) to generate a response for tasks in the benchmark dataset. The lower horizontal line in each graph represents the performance of the model using randomly selected examples. The higher horizontal line in each graph represents the upper bound performance achieved through brute force testing, as described above with respect to FIG. 4.

The first bar from the left in each graph represents the accuracy of responses when the sequence optimization model is trained across various benchmark dataset queries without fine-tuning for the target benchmark dataset queries for which responses are generated. The second bar from the left in each graph represents the accuracy of responses when the sequence optimization model is trained across various benchmark dataset queries and then fine-tuned for the target dataset for which responses are generated. As shown, both approaches generally exceed the performance of randomly selected examples. In many cases, the performance is near the upper bound. Also, the fine-tuned embodiment generally achieves better results than the embodiment that is not fine-tuned.

The third bar from the left in each graph represents the accuracy of responses when the sequence optimization model is trained using results from each machine learning model other than the target machine learning model without fine-tuning for the target machine learning model on which responses are generated. The fourth bar from the left in each graph represents the accuracy of responses when the sequence optimization model is trained using results from each machine learning model other than the target machine learning model and then fine-tuned for the target machine learning model on which responses are generated. As shown, both approaches generally exceed the performance of randomly selected examples. In many cases, the performance is near the upper bound. Also, the fine-tuned embodiment generally achieves better results than the embodiment that is not fine-tuned.

### Example Operations Related to Automated Determination of an Optimal Combination of Few-Shot Examples for Few-Shot Learning Processes

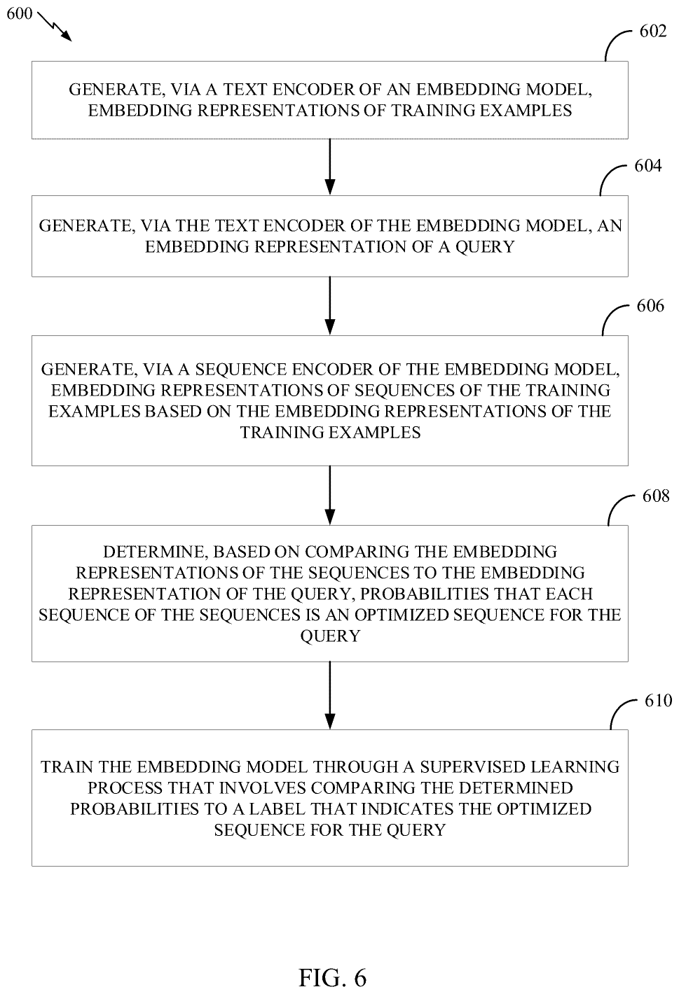

FIG. 6 depicts example operations 600 related to automated determination of an optimal combination of few-shot examples for few-shot learning processes. For example, operations 600 may be performed by one or more of the components described with respect to FIG. 1, FIG. 2, or FIG. 3.

Operations 600 begin at step 602 with generating, via a text encoder of an embedding model, embedding representations of training examples.

Operations 600 continue at step 604 with generating, via the text encoder of the embedding model, an embedding representation of a query.

Operations 600 continue at step 606 with generating, via a sequence encoder of the embedding model, embedding representations of two or more sequences of the training examples based on the embedding representations of the training examples.

Operations 600 continue at step 608 with determining, based on comparing the embedding representations of the sequences to the embedding representation of the query, probabilities that each sequence of the two or more sequences is a most optimized sequence of the two or more sequences for the query. Some embodiments provide that determining the probabilities is based on generating a score for each sequence of the two or more sequences based on the comparing. In certain embodiments, generating the score is based on determining the dot product of an embedding representation of a sequence of the two or more sequences and the embedding representation of the query. According to some embodiments, determining the probabilities is further based on providing the scores to a softmax layer of a neural network comprising the embedding model.

Operations 600 continue at step 610 with modifying parameters of the embedding model through a supervised contrastive learning process that involves evaluating the determined probabilities based on a label that indicates the most optimized sequence of the two or more sequences for the query. Certain embodiments provide that the modifying further comprises fine-tuning the embedding model based on additional training sequences corresponding to a particular query. According to some embodiments, the modifying further comprises fine-tuning the embedding model based on additional training sequences corresponding to a particular target language processing machine learning model. In certain embodiments, evaluating the determined probabilities based on the label further comprises calculating binary cross entropy loss for the probabilities.

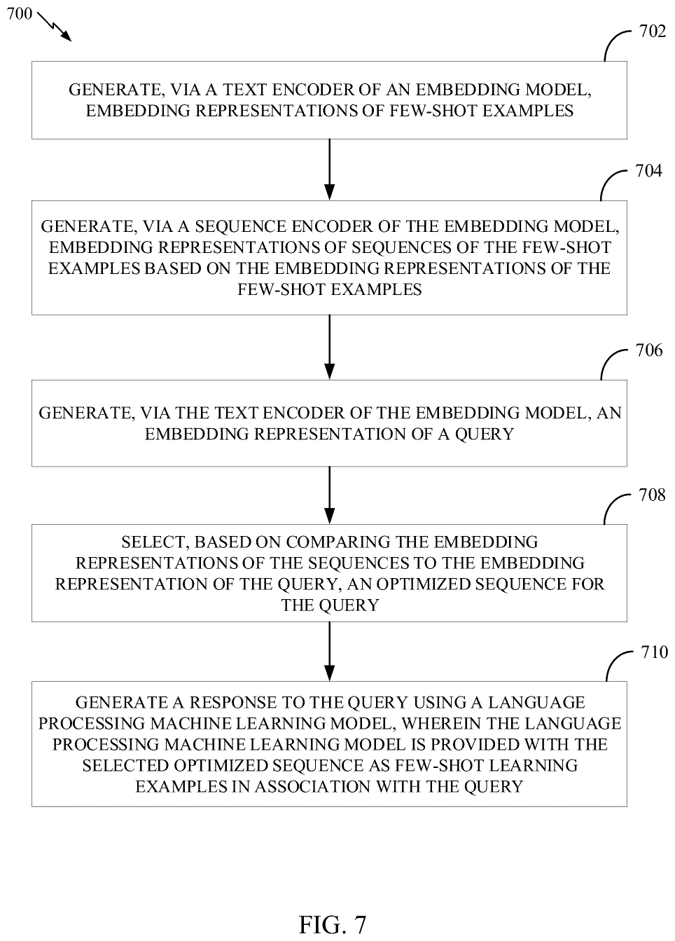

FIG. 7 depicts additional example operations 700 related to automated determination of an optimal combination of few-shot examples for few-shot learning processes. For example, operations 700 may be performed by one or more of the components described with respect to FIG. 1, FIG. 2, or FIG. 3.

Operations 700 begin at step 702 with generating, via a text encoder of an embedding model, embedding representations of few-shot examples.

Operations 700 continue at step 704 with generating, via a sequence encoder of the embedding model, embedding representations of two or more sequences of the few-shot examples based on the embedding representations of the few-shot examples.

Operations 700 continue at step 706 with generating, via the text encoder of the embedding model, an embedding representation of a query.

Operations 700 continue at step 708 with selecting, based on comparing the embedding representations of the two or more sequences to the embedding representation of the query, a most optimized sequence of the two or more sequences for the query. Some embodiments provide that the most optimized sequence is selected based on generating a score for each sequence of the two or more sequences. In certain embodiments, the scores are generated based on determining, for each sequence of the two or more sequences, the dot product of the embedding representation of the sequence and the embedding representation of the query. According to some embodiments, comparing of the embedding representations of the two or more sequences to the embedding representation of the query comprises searching a vector store in which sequence embeddings are stored based on the embedding representation of the query using a nearest neighbor algorithm.

Operations 700 continue at step 710 with generating a response to the query using a language processing machine learning model, wherein the language processing machine learning model is provided with the selected most optimized sequence as few-shot learning examples in association with the query.

In some embodiments, the embedding model has been trained through a supervised contrastive learning process that comprises selecting a training sequence from a plurality of training sequences and comparing the selected training sequence to a label comprising a most optimized training sequence. Certain embodiments provide that the embedding model has been fine-tuned using additional training sequences that are associated with the query. According to some embodiments, the embedding model has been fine-tuned using additional training sequences that are associated with the language processing machine learning model.

### Example of a Processing System for Detecting Hallucinations in Language Model Outputs

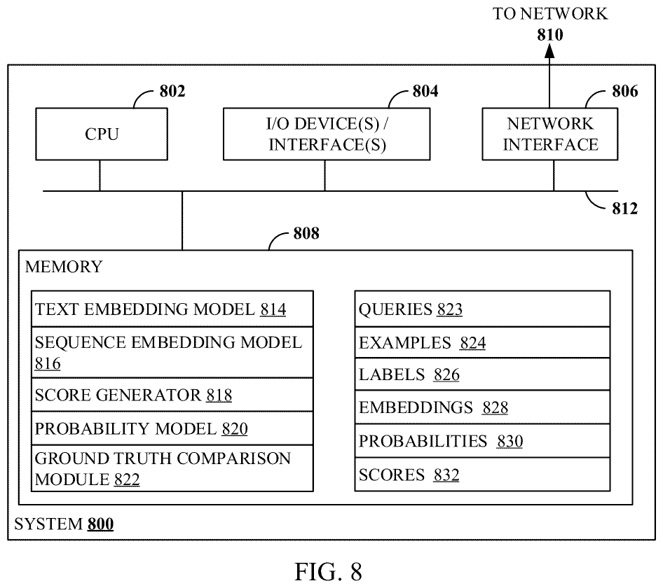

FIG. 8 illustrates an example system 800 with which embodiments of the present disclosure may be implemented. For example, system 800 may be configured to perform operations 600 of FIG. 6 or operations 700 of FIG. 7, and/or to implement one or more components as in FIG. 1, FIG. 2, or FIG. 3.

System 800 includes a central processing unit (CPU) 802, one or more I/O device interfaces that may allow for the connection of various I/O devices 804 (e.g., keyboards, displays, mouse devices, pen input, etc.) to the system 800, network interface 806, a memory 808, and an interconnect 812. It is contemplated that one or more components of system 800 may be located remotely and accessed via a network 810. It is further contemplated that one or more components of system 800 may comprise physical components or virtualized components.

CPU 802 may retrieve and execute programming instructions stored in the memory 808. Similarly, the CPU 802 may retrieve and store application data residing in the memory 808. The interconnect 812 transmits programming instructions and application data, among the CPU 802, I/O device interface 804, network interface 806, and memory 808. CPU 802 is included to be representative of a single CPU, multiple CPUs, a single CPU having multiple processing cores, and other arrangements.

Additionally, the memory 808 is included to be representative of a random access memory or the like. In some embodiments, memory 808 may comprise a disk drive, solid state drive, or a collection of storage devices distributed across multiple storage systems. Although shown as a single unit, the memory 808 may be a combination of fixed and/or removable storage devices, such as fixed disc drives, removable memory cards or optical storage, network attached storage (NAS), or a storage area-network (SAN).

As shown, memory 808 includes text embedding model 814, sequence embedding model 816, score generator 818, probability model 820, and ground truth comparison module 822. In some embodiments, text embedding model 814 may be representative of text embedding model 307 of FIG. 3 or embedding layer 120 of FIG. 1. Sequence embedding model 816 may be representative of sequence embedding model 310 of FIG. 3 or LSTM layer 130 of FIG. 1. Score generator 818 may be score generator 320 of FIG. 3 or scoring layer 140 of FIG. 1. Probability model 820 may be probability model 210 of FIG. 2 or softmax layer 150 of FIG. 1. Ground truth comparison module 822 may be representative of ground truth comparison module 220 of FIG. 2.

Memory 808 further comprises queries 823, which may correspond to query 102 of FIG. 1, FIG. 2, or FIG. 3. Memory 808 further comprises examples 824, which may correspond to examples 303A-Z of FIG. 3. Memory 808 further comprises labels 826, which may correspond to ground truth labels 214 of FIG. 2. Memory 808 further comprises embeddings 828, which may correspond to query embedding 302, example embeddings 305A-Z, or sequence embeddings 315A-B of FIG. 3. Memory 808 further comprises probabilities 830, which may correspond to probabilities 112 of FIG. 1 or FIG. 2. Memory 608 further comprises scores 832, which may correspond to scores 208 of FIG. 2.

It is noted that in some embodiments, system 800 may interact with one or more external components, such as via network 810, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a sequence optimization model to determine an optimized sequence of examples for few-shot learning, comprising:
generating, via a text encoder of an embedding model, embedding representations of training examples;
generating, via the text encoder of the embedding model, an embedding representation of a query;
generating, via a sequence encoder of the embedding model, embedding representations of two or more sequences of the training examples based on the embedding representations of the training examples;
determining, based on comparing the embedding representations of the sequences to the embedding representation of the query, probabilities that each sequence of the two or more sequences is a most optimized sequence of the two or more sequences for the query; and
modifying parameters of the embedding model through a supervised contrastive learning process that involves evaluating the determined probabilities based on a label that indicates the most optimized sequence of the two or more sequences for the query.

2. The method of claim 1, wherein the modifying further comprises fine-tuning the embedding model based on additional training sequences corresponding to a particular query.

3. The method of claim 1, wherein the modifying further comprises fine-tuning the embedding model based on additional training sequences corresponding to a particular target language processing machine learning model.

4. The method of claim 1, wherein determining the probabilities is based on generating a score for each sequence of the two or more sequences based on the comparing.

5. The method of claim 4, wherein generating the score is based on determining the dot product of an embedding representation of a sequence of the two or more sequences and the embedding representation of the query.

6. The method of claim 4, wherein determining the probabilities is further based on providing the scores to a softmax layer of a neural network comprising the embedding model.

7. The method of claim 1, wherein evaluating the determined probabilities based on the label further comprises calculating binary cross entropy loss for the probabilities.

8. A method for determining an optimized sequence of examples for few-shot learning, comprising:
generating, via a text encoder of an embedding model, embedding representations of few-shot examples;
generating, via a sequence encoder of the embedding model, embedding representations of two or more sequences of the few-shot examples based on the embedding representations of the few-shot examples;
generating, via the text encoder of the embedding model, an embedding representation of a query;
selecting, based on comparing the embedding representations of the two or more sequences to the embedding representation of the query, a most optimized sequence of the two or more sequences for the query; and
generating a response to the query using a language processing machine learning model, wherein the language processing machine learning model is provided with the selected most optimized sequence as few-shot learning examples in association with the query.

9. The method of claim 8, wherein the embedding model has been trained through a supervised contrastive learning process that comprises selecting a training sequence from a plurality of training sequences and comparing the selected training sequence to a label comprising a most optimized training sequence.

10. The method of claim 9, wherein the embedding model has been fine-tuned using additional training sequences that are associated with the query.

11. The method of claim 9, wherein the embedding model has been fine-tuned using additional training sequences that are associated with the language processing machine learning model.

12. The method of claim 8, wherein the most optimized sequence is selected based on generating a score for each sequence of the two or more sequences.

13. The method of claim 12, wherein the scores are generated based on determining, for each sequence of the two or more sequences, the dot product of the embedding representation of the sequence and the embedding representation of the query.

14. The method of claim 8, further comprising storing the embedding representations of the two or more sequences in a vector store, wherein the comparing of the embedding representations of the two or more sequences to the embedding representation of the query comprises searching the vector store based on the embedding representation of the query using a nearest neighbor algorithm.

15. A system for training a sequence optimization model to determine an optimized sequence of examples for few-shot learning, comprising:
one or more processors; and
a memory comprising instructions that, when executed by the one or more processors, cause the system to:
generate, via a text encoder of an embedding model, embedding representations of training examples;
generate, via the text encoder of the embedding model, an embedding representation of a query;
generate, via a sequence encoder of the embedding model, embedding representations of two or more sequences of the training examples based on the embedding representations of the training examples;
determine, based on comparing the embedding representations of the sequences to the embedding representation of the query, probabilities that each sequence of the two or more sequences is a most optimized sequence of the two or more sequences for the query; and
modify parameters of the embedding model through a supervised contrastive learning process that involves evaluating the determined probabilities based on a label that indicates the most optimized sequence of the two or more sequences for the query.

16. The method of claim 15, wherein the modifying further comprises fine-tuning the embedding model based on additional training sequences corresponding to a particular query.

17. The method of claim 15, wherein the modifying further comprises fine-tuning the embedding model based on additional training sequences corresponding to a particular target language processing machine learning model.

18. The method of claim 15, wherein determining the probabilities is based on generating a score for each sequence of the two or more sequences based on the comparing, wherein generating the score is based on determining the dot product of an embedding representation of a sequence of the two or more sequences and the embedding representation of the query.

19. The method of claim 15, wherein determining the probabilities is based on generating a score for each sequence of the two or more sequences based on the comparing, wherein determining the probabilities is further based on providing the scores to a softmax layer of a neural network comprising the embedding model.

20. The method of claim 15, wherein determining the probabilities is based on generating a score for each sequence of the two or more sequences based on the comparing, wherein evaluating the determined probabilities based on the label further comprises calculating binary cross entropy loss for the probabilities.
